(19) United States
(12) Patent Application Publication
(10) Pub. No.: US 2009/0291704 A1
(43) Pub. Date: Nov. 26, 2009

(54) Method of Establishing Parallel Group Services Over Disparate Communication Networks

(75) Inventors: Michael F. Korus, Eden Prairie, MN (US); James A. Marocchi, Winfield, IL (US); John C. Kay, Elgin, IL (US); Daniel J. Naylor, Inverness, IL (US); Hemang F. Patel, Hoffman Estates, IL (US); Marianne J. Stanke, Elmhurst, IL (US); Wilson P. Wiedenheft, Barrington, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/124,223

(22) Filed: May 21, 2008

(51) Int. Cl. H04B 7/00

(52) U.S. Cl. 455/519

(57) ABSTRACT

Users affiliated with a first narrowband talk group or participating in a narrowband talk group communication are able to establish a parallel communication group with the same users of the first talk group using alternate communication devices to enable transmission of multimedia over the disparate communication networks. One or more databases store and correlate information regarding the users of the narrowband talk group, as well as information regarding the user's communication devices and access technologies employed by the communication devices to determine the possible broadband groups available and an acceptable access technology to transmit the multimedia to the broadband group/data group users. The disparate network group manager informs the users of the narrowband talk group of the presence or availability of the parallel broadband group and establishes the parallel broadband group session when requested to do so by a user of the narrowband talk group.

### TECHNICAL FIELD OF THE DISCLOSURE

This disclosure relates generally to communication systems, and more particularly, the present disclosure pertains to a method of enabling a group of users affiliated using a first access technology, to trigger the establishment of a second communication with the same group of users, using alternate access technologies with alternate technology communication devices.

### BACKGROUND OF THE DISCLOSURE

One of the most utilized features in public safety systems and other systems utilizing group communications systems is a feature which allows a user or users to communicate with a group of users with the press of a button, commonly known as push-to-talk. This feature allows the user to facilitate a group conversation without making several individual communications to communicate within the group. On narrowband systems, the push-to-talk feature is limited to voice services.

With the growing demand for bandwidth intensive data applications, users are turning to broadband technologies to supplement their narrowband voice systems. This trend is resulting in users having multiple communication devices, or devices with multiple communications capabilities, one for mission critical voice and one or more for broadband data applications such as communication device management, image transfer, video, and intranet and internet access.

Currently, there is a focus on converging multiple media services on a single device having multiple capabilities, but there is no method for fully utilizing the narrowband and broadband communication resources a user currently possesses. For example, if a user initiates a communication to multiple users on a narrowband device such as a portable radio, and subsequently desires to send the same users of the first communication a second communication or media to view, such as a video, the user would need to proceed through a number of steps. Depending on the type of media being transferred, a user needs to first obtain at least one device capable of transmitting the video. Then the user would need to know which type of broadband devices the other users of the group communication have as well as the contact information for the communication devices and then input the contact information of the communication devices to which the media is being transmitted for each of the group's users individually.

It would be desirable to be able to establish a group communication with a first access technology using a first access technology device and trigger the establishment of a parallel group communication using different access technologies with second technology devices, when users of the group have both types of access technology devices. In other words, there is a need to associate or correlate a user's narrowband and broadband communication devices to easily and conveniently provide multi-media to the user over the best possible medium.

### BRIEF DESCRIPTION OF THE FIGURES

The benefits and advantages of the present disclosure will become more readily apparent to those of ordinary skill in the relevant art after reviewing the following detailed description and accompanying drawings, wherein:

FIG. 1 is a network diagram of an embodiment of the present method using single mode devices to establish a parallel multimedia group session used to implement the present disclosure;

FIG. 2 is a network diagram of an embodiment of the present method, using single mode and multi-mode devices to establish a parallel multimedia group session used to implement the present disclosure;

FIG. 3 is a flowchart illustrating an embodiment for establishing a parallel multimedia group session where parallel group devices are selected after active selection of parallel group option.

FIG. 4 is a flow chart illustrating an embodiment for establishing a parallel multimedia group session where parallel group devices are selected before active selection of the parallel group option.

Skilled artisans will appreciate that elements in the figures are illustrated for simplicity and clarity and have not necessarily been drawn to scale. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

A system and method for efficiently and dynamically correlating and establishing parallel multimedia communication services among multiple disparate communication devices utilizing multiple disparate access technologies is herein disclosed. The present disclosure illustrates a method to allow users of a first communication group to easily, simultaneously, and automatically establish a parallel second communication group with a second device of the users of the first communication group to allow simultaneous transmission of media to those users. A communication group includes narrowband and/or broadband groups, with wired, as well as wireless access technologies. Narrowband communication groups include, but are not limited to, narrowband talk groups, while broadband communication groups, hereafter “broadband group(s)”, include, but are not limited to, talk groups, data groups, multimedia groups, and messaging groups. The present disclosure correlates and maps the identifications of users and identifications of their respective narrowband and broadband communication devices with the attributes of the narrowband and broadband communication devices and access technologies. The narrowband user and narrowband talk group identifications and broadband user and broadband group identifications, all belonging to or associated with the same user are mapped. Parallel communication groups across the disparate networks may be enabled and established, and a pathway or pathways for the communication group's media to flow, hereafter, a “group communication pathway(s),” may also be established.

In a narrowband system, such as an APCO Project 25 narrowband system, every communication device that is allowed on the system is provisioned in the system. In one exemplary narrowband system, the communication device identification (“ID”) is provisioned in the database. When a communication device is turned on, the communication device registers its ID with the narrowband system, which verifies that the communication device is allowed on the system. It is understood that the APCO P25 system is used as example only and any communications systems capable of supporting the present disclosure is included and intended to be within the spirit and scope of this disclosure.

To support messaging to a specific user, i.e., a person rather than the communication device, narrowband systems may also support user IDs. Thus, messages can be targeted to a user, regardless of which communication device the user is logged into. The narrowband system is able to then bind the user ID to the communication device ID.

Narrowband communication groups, hereafter referred to as narrowband talk groups, are provisioned in the communication system as well. The users affiliated with a narrowband talk group, however, are ever changing, dynamic, and thus, changes in the users affiliated with the narrowband talk group at any given time are often tracked in a database. The dynamic tracking of users of the narrowband talk group is sometimes referred to as affiliation. When the user of a communication device selects a narrowband talk group with which to become affiliated, the communication device sends an affiliation message to the communication system that creates a binding between the user's user ID, the communication device ID, and the narrowband talk group ID. The narrowband talk group is dynamic; as users select different narrowband talk groups, the system's database updates the mapping of communication device IDs to narrowband talk group IDs.

Broadband systems support many types of IDs. Generally, applications do not address broadband communication devices by their broadband communication device ID specifically as is done in narrowband systems. In broadband systems, applications address devices by a user ID. In other words, the broadband device is acknowledged based on the user who is logged into the broadband communication device, not the device itself.

Group IDs in broadband groups come in many varieties, depending on the access technology and core applications. An access technology is a technology or protocol which provides communication devices with access to the communications network while an application allows a user to perform specific functions once physical access to the network is established. Each access technology and application has its own group management processes and identifications.

A communication device, because of its design, programming, or system and network affiliations, has attributes or parameters that define the communication device's capabilities. In general, the attributes of a communication device impacts the type of media that can be sent to the communication device, the speed with which the media may be sent, the mode of display of the media, the available software the communication device has, and the type of encryption the communication device has. The attributes may also refer to the user's privileges, the communication device itself, as well as the attributes of the group session, and include the IDs of the users involved in the session, the number of communication devices associated with each user, and their preferred broadband communication device.

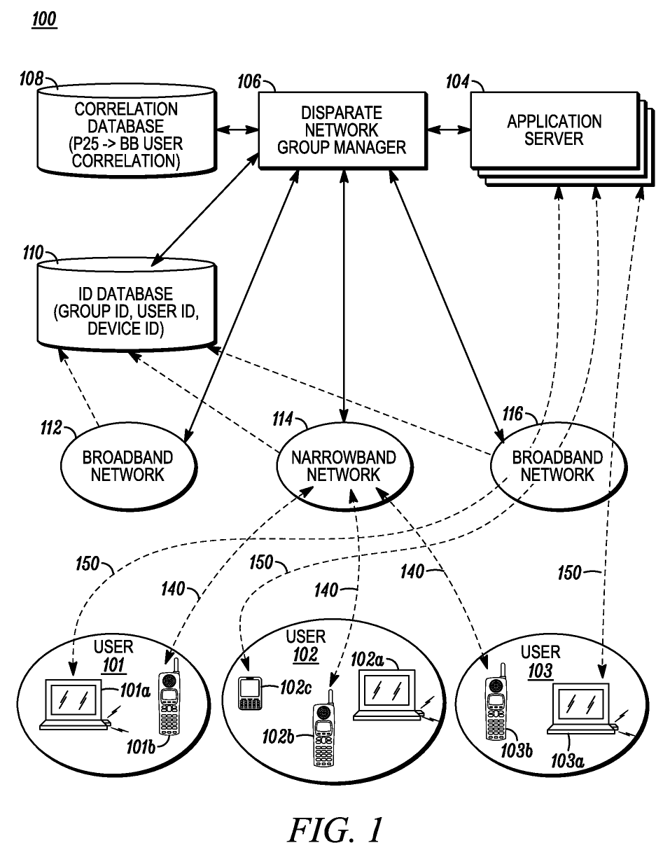

Referring now to the figures and in particular FIG. 1, there is shown a diagram illustrating an embodiment of the system of the present disclosure. There is shown a system 100 with a user 101, a user 102, and a user 103. User 101 has two types of wireless communication devices, a broadband computer 101a and a narrowband portable radio 101b. User 102 has three wireless communication devices: a broadband computer 102a, a narrowband portable radio 102b, and a broadband personal digital assistant 102c. User 103 has two communication devices, a broadband computer 103a and a narrowband portable radio 103b. It is understood that a single user may have multiple devices, each operating across disparate access technologies, and/or may have a single device which operates across multiple access technologies and that the present disclosure is not meant to exclude any technology device.

Each of the communication devices 101a, 101b, 102a, 102b, 102c, 103a, 103b, has a unique communication device ID and associated attributes stored in an ID database 110. Also stored in the ID database 110 are, among other things, narrowband group IDs, broadband group IDs, and user IDs, “IDs”. The attributes are associated with the IDs within a correlation database 108. In the present disclosure, the IDs and correlation information are populated in one or more individual or group policy management systems or repositories, hereafter “database” or “databases”. The term database is not intended to limit the present disclosure to one database, but is intended to allow for one or more databases to perform the functions disclosed herein. It will be understood and appreciated by those in the art that the term “database” encompasses all hardware and software components necessary for the database(s) to perform the functions disclosed.

The ID database 110 gathers the IDs of each of the Users' 101, 102, and 103 devices, as well as the attributes of each device, access networks, and access technology. The correlation database 108 synchronizes or correlates all or many of the user's devices to each other and to other users whose device IDs and attributes are stored in the ID database 110. The correlation database 108 also correlates the user's 101, 102, and 103 associated communication groups and networks with the user's communication device IDs. The correlation database 108 maps the collection of individual communication device IDs to its respective user, regardless of the access technology or network utilized by the communication device. For example, the correlation database 108 correlates user 101 with both communication devices 101a and 101b, while it correlates user 102 with communication devices 102a, 102b, and 102c and user 103 to communication devices 103a and 103b. Those skilled in the art will appreciate that one database, or multiple databases together, may perform the functions disclosed herein, and that databases 108, 110 are shown for clarification and explanation purposes only.

The correlation and ID databases 108, 110 are accessible to one or more disparate network group managers 106. When a parallel broadband group is requested 150, the disparate network group manager 106 determines the appropriate devices, narrowband and/or broadband, available for a given application. The disparate network group manager 106 also considers and manages information regarding the various broadband and narrowband communication networks 112, 114, and 116 and associated attributes of each. The disparate network group manager also considers the technological applications 104 necessary and/or available to service communications requests. The synchronization of the user's devices to each other and to the user's communication group affiliations, as well as network and application data provides a novel means for the establishment of parallel communication group services across multiple disparate networks among the various users.

For example, in FIG. 1, a narrowband talk group communication 140 is in session between users 101, 102, and 103 using narrowband communication devices 101b, 102b, and 103b, respectively. The affiliation of users 101, 102, and 103 with the narrowband talk group 140 signals the disparate network group manager 106 that a parallel communication group session also may be requested and the disparate network group manager 106 prepares for the request. While FIG. 1 shows a narrowband talk group is actively established, an established communication is not necessary to trigger the formation of a parallel communication group. Simply affiliating with the talk group can trigger the formation of a communication group by the disparate network group manager 106.

Having affiliated with talk group 140 user 101 requests 150 that a parallel broadband group is established in order to send media from user 101's communication device 101a. The disparate network group manager 106 processes the request and accesses the ID database 110 and correlation database 108 to determine which communication devices for user 102 and user 103 are available and capable of forming a parallel broadband group with and receive the transmission of media from user 101.

In FIG. 1, user 101 has broadband device 101a available, user 102 has broadband devices 102a and 102c available, and user 103 has broadband devices 103a available. The disparate network group manager 106 determines that the most appropriate devices for the media to be sent are 101a, 102c and 103a. A parallel broadband group 150 is recognized with broadband devices 101a, 102c, and 103a. The disparate network group manager 106 configures the parallel broadband group for the chosen broadband devices and informs the users 101, 102, and 103 that the parallel broadband group 150 is available or present. It is anticipated that the announcement is shown to the user on the graphical user interfaces of the chosen parallel broadband group devices.

Once the parallel broadband group is established, any user 101, 102, or 103 may transmit and receive media through the parallel broadband group. In the present embodiment, user 101 may transmit the media to users 102 and 103 through the parallel broadband group formed. As is illustrated, the communication devices through which the parallel broadband group is formed do not have to be the same technology nor do they need to operate on the same network or system.

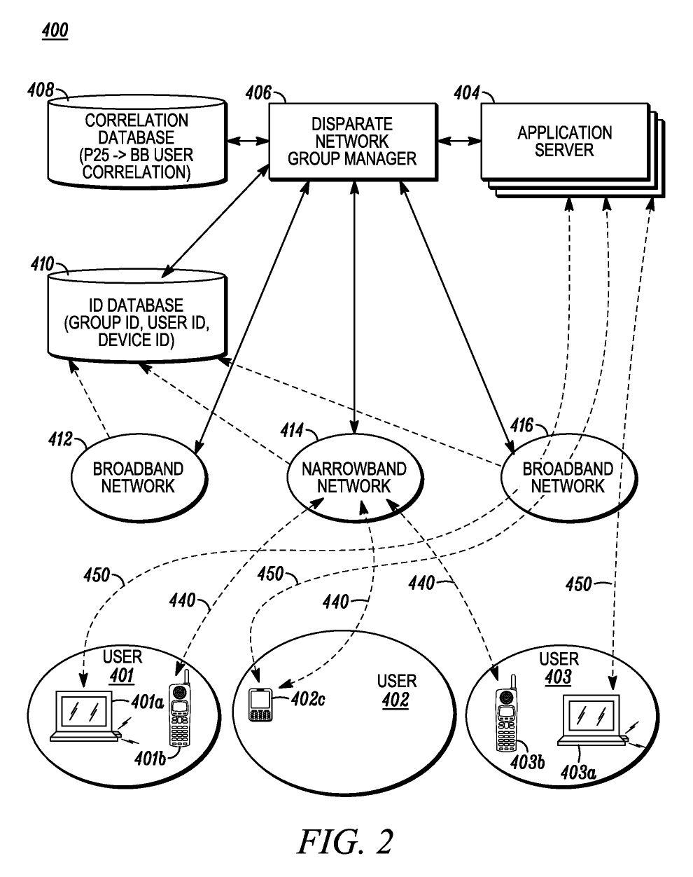

Turning now to FIG. 2, an alternate embodiment of the present disclosure is shown in which users of a narrowband talk group are affiliated with one another, wherein both broadband and narrowband devices are used, triggering the formation of a broadband group by a disparate network group manager. In FIG. 2, a narrowband talk group communication 440 is in session between users 401, 402, and 403 using narrowband communication devices 401b and 403b and broadband device 402c. Communication device 402c is capable of transmitting and receiving both narrowband and broadband transmissions.

Upon affiliation of the users 401, 402, 403 to the talk group 440, a parallel broadband group is configured by the disparate network group manager 406. The disparate network manager 406 accesses the ID database 410 and correlation database 408 to determine which communication devices for user 402 and user 403 are available and also capable of forming a parallel broadband group with and receive the transmission from user 401. User 401 has broadband device 401a available, user 402 has broadband device 402c available, and user 403 has broadband device 403a available. The disparate network group manager 406 determines that the most appropriate devices for media to be sent to are communication devices 401a, 402c and 403a. The disparate network group manager 406 configures and announces the presence of a parallel broadband group 450 through which broadband devices 401a, 402c and 403a communicate.

The disparate network group manager informs the users 401, 402, and 403 of the presence of the parallel broadband group 450 on the graphical user interfaces of the chosen devices. Once the parallel broadband group is present, any user 401, 402, or 403 may request establishment of the parallel broadband group. If establishment of a parallel broadband group 450 is actively requested by the user, then the disparate network group manager 406 establishes the parallel broadband group between user 401, user 402, and user 403 using communication devices 401a, 402c, and 403a. In this example, the disparate network group manager 406 processes the request 450 to establish a parallel broadband group from user 401. In the present embodiment, user 401 may transmit the media to users 402 and 403 through the parallel broadband group formed. As is illustrated, the communication devices through which the parallel broadband group 450 is formed do not have to be the same technology nor do they need to operate on the same network or system.

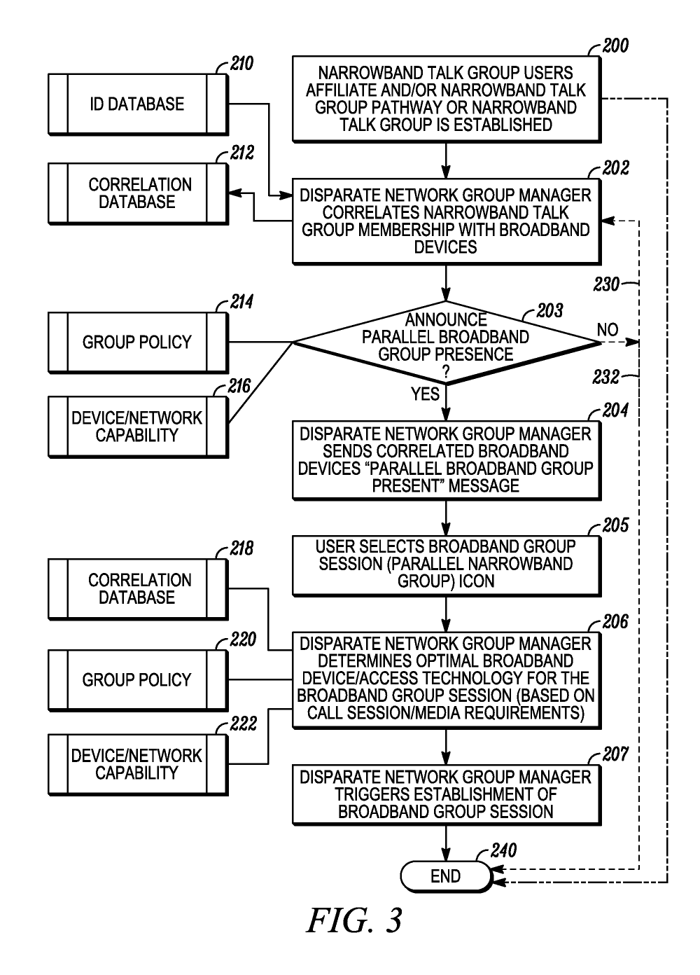

Turning now to FIG. 3, a flowchart of one embodiment of the present disclosure is illustrated. In this embodiment, the user indicates the type of media to be sent and the disparate network group manager determines one or more optimal modes of delivery for the group. The mode of delivery for the media may be via narrowband or broadband communication technologies. Users of a narrowband talk group affiliate and/or a narrowband talk group session is established, block 200. It is important to note that a first communication need not be formally established in order to trigger configuration of a second parallel broadband group. The formation of a narrowband talk group via the process of affiliation is sufficient to trigger the formation of a parallel communication group on a second technology and the subsequent announcing of the presence of the second parallel communication group on the second access technology.

In the embodiment of FIG. 3, for example, the narrowband talk group users affiliate with the talk group, but may not necessarily establish a communication. The narrowband talk group communication may be established by active selection of a function, such as push-to-talk. The user's affiliation with the narrowband talk group signals the disparate network group manager to configure a parallel broadband group. The disparate network group manager correlates the selected talk group users with their corresponding broadband devices, blocks 210, 212 using the talk group users' user IDs. The ID database, block 210, includes the user IDs (e.g., johndoe@abcmobile.net), communication device IDs (e.g., IMSI—International Mobile Subscriber Identifier or P25 SUID-Subscriber Unit Identifier), and group IDs (P25 TalkGroup ID, push-to-talk over cellular-group ID). The correlation database, block 212 contains the mapping/correlation of the narrowband groups to the broadband user identifiers. Again, the functions disclosed may be performed by one or a plurality of databases and the present embodiment is for explanation purposes only and is not intended to limit the present disclosure.

The decision to announce the presence of a parallel broadband group is based on policy (set of rules) and the capabilities of the network and communication devices, block 203. Group policy refers to the set of rules applied when creating a group, such as those which apply to device capabilities, network capabilities, user permissions, user privileges, time of day, security, location, group preferences (e.g., critical users must be available, or do not care), etc. Group policies are considered by the disparate network group manager when determining possible parallel broadband communication pathways, block 203. In addition, capabilities such as media type supported, screen size, and services supported are correlated along with the user IDs and device IDs, block 216.

If it is decided not to create a parallel broadband group, the disparate network group manager will continue in standby mode or continue looping, 230, until a parallel broadband group is warranted or until the narrowband talk group ends communication, block 240. If policy dictates, the disparate group manager may terminate the attempt to setup the parallel broadband group, block 240.

If it is decided that a parallel broadband group should be established, the disparate network manager generates a message to announce the presence of a parallel group to broadband devices that are available for communication, block 204. For example, a user's broadband devices may display an icon on their graphical user interface indicating the presence of a “broadband group”. Selection of the icon signals the disparate network group manager that a user desires to create a parallel broadband group communication pathway, block 205.

Once a user has requested that a parallel broadband group communication pathway be established, the disparate network group manager determines the optimal broadband communication device and access technology for the parallel broadband group based on the media the user wants to transmit over the parallel broadband communication pathway, block 206. The disparate network group manager analyzes the type of media session being established in the parallel broadband group and selects the optimal device (if user has multiple broadband devices) or the optimal access technology (if user has a multimode device, e.g., one device that supports WiFi and EVDO). The disparate network group manager references the correlation database for the set of possible devices that can be used, block 212. The disparate network group manager also references the narrowband talk group's and broadband group's policies regarding rules (e.g., user preferences, for video WiFi shall be preferred (free access), EVDO second), block 220. In addition communication device and network capabilities information is accessed to obtain capability/attribute information, block 222. The disparate network group manager then establishes the parallel broadband group, block 207 between the broadband devices of the users of the narrowband talk group.

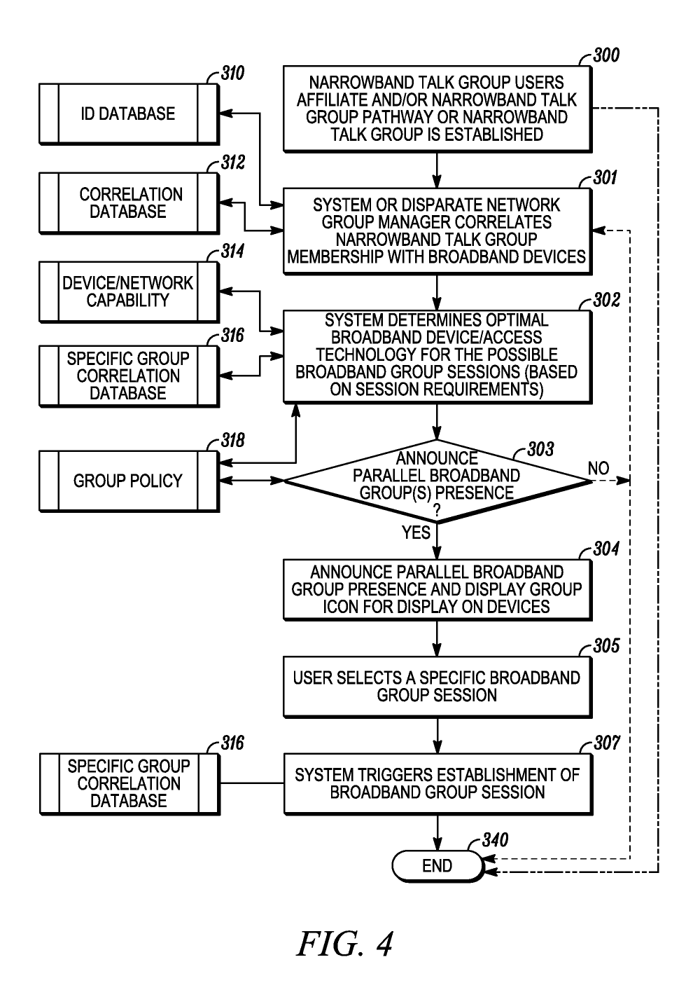

FIG. 4 is a flowchart of another embodiment of the present disclosure. In this embodiment, all the parallel communication groups available or possible between the narrowband talk group users are broadcast to all the broadband communication devices correlating to the user IDs of the users of a narrowband talk group and the user selects the appropriate broadband device to send the media selected.

The users of a narrowband talk group affiliate and/or a narrowband talk group session is established, block 300. In this embodiment, the narrowband talk group is established by pressing a button, commonly known as push-to-talk. The system (which may or may not include the disparate network group manager) correlates the narrowband talk group users with their corresponding broadband devices, blocks 301, 310, 312. The ID database 310 includes the user IDs (e.g., johndoe@abcmobile.net), communication device IDs (e.g., IMSI—International Mobile Subscriber Identifier or P25 SUID—Subscriber Unit Identifier), and group IDs (e.g., P25 TalkGroup ID, push-to-talk-over-cellular-Group ID). The correlation database 312 contains the mapping/correlation of the narrowband talk groups to broadband user identifiers.

In FIG. 4, the system or disparate network group manager provides the parallel broadband group devices with a set of “click-to-group” options based on realtime device information, such as the presence of a user or communication device. For example, a “click-to” menu may be displayed as a series of icons on the communication device or a pull down menu. The menu is comprised of click-to options, such as “click to start encrypted video stream”, “click to send image”, “click to start multi-media texting plus video streaming”, and the like.). Each of these “click-to” groups may be composed of a subset of users depending on communication device capabilities (e.g., secure group, video capable group, Fire Chiefs only, etc.). Thus, the system references capabilities and policy information to identify and create a set of groups to be sent to the users' broadband devices block 302.

The decision to announce a parallel communication group is based on policy (set of rules) and the capabilities of the network and communication devices, block 303. Group policy refers to the set of rules applied when creating a communication group, block 318. Rules apply to device capabilities, network capabilities, user permissions, user privileges, time of day, security, location, group preferences (e.g., critical users must be available, or do not care), etc. The communication device and network capability are also taken into consideration by the disparate network group manager, block 314. Capabilities such as media type supported, screen size, and services supported are correlated along with the user IDs and device IDs.

If the decision to announce the presence of a parallel communication group is confirmed, the parallel communication group presence is displayed on all available broadband devices of the broadband group, block 304. When and if a user desires to establish the parallel broadband group communication pathway, the user selects one of the announcements to signal the system, block 305. The disparate network group manager analyzes the selected group, references the specific users in the Specific Group Correlation Database block 316, and establishes the broadband group, block 307.

While the present disclosure is susceptible of embodiment in various forms, there is shown in the drawings and described above described a presently preferred embodiment with the understanding that the present disclosure is to be considered an exemplification of the disclosure and is not intended to limit the disclosure to the specific embodiment illustrated.

It should be further understood that the title of this section of this specification, namely, “Detailed Description of the Disclosure”, relates to a requirement of the United States Patent Office, and does not imply, nor should be inferred to limit the subject matter disclosed herein.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

We claim:

1. A method for enabling a first communication group of a first access technology with first access technology communication devices to trigger the development of a second communication group of a second access technology with second access technology communication devices, wherein users of the first communication group have first access technology communication device and second access technology communication devices, the method comprising the steps of:
configuring one of the first communication group, a first communication group communication pathway, and a first communication group communication using the first access technology communication devices;
determining a configuration of one of the second communication group, a second communication group communication pathway, and a second communication group communication using the second access technology communication devices of the users of the first communication group; and
announcing a presence of one of the second communication group, the second communication group communication pathway, and the second communication group communication on the second access technology communication devices of the users of the first communication group if the one of the second communication group, the second communication group communication pathway, and the second communication group communication is feasible.

2. The method of claim 1, wherein the first access technology communication device is one of a narrowband device and a broadband device.

3. The method of claim 1, wherein the second access technology communication device is one of a narrowband device and a broadband device.

4. The method of claim 1, wherein users of the second communication group have dissimilar second access technology communication devices and the announcement of the presence of the one of the second communication group, the second communication group communication pathway, and the second communication group communication is available to each of the dissimilar second access technology communication devices.

5. The method of claim 1, further including the step of:
terminating an announcement of the presence of the one of the second communication group, the second communication group communication pathway, and the second communication group communication.

6. The method of claim 1, further comprising the step of:
establishing one of the first communication group, the first communication group communication pathway, and the first communication group communication using the first access technology with the first access technology communication devices.

7. The method of claim 6, further including the step of:
terminating the one of the first communication group, the first communication group communication pathway, and the first communication group communication.

8. The method of claim 1, further comprising the step of:
establishing one of the second communication group, the second communication group communication pathway, and the second communication group communication using the second access technology communication devices.

9. The method of claim 8, further including the step of:
terminating the one of the second communication group, the second communication group communication pathway, and the second communication group communication.

10. The method of claim 1, further including the step of:
transmitting the second communication group communication over the second communication group communication pathway.

11. The method of claim 1, further including the step of:
determining an appropriate second access technology communication device from a group of second access technology communication devices for transmitting the second communication group communication.

12. The method of claim 1, wherein configuring at least one of the first communication group, the first communication group communication pathway, and the first communication group communication signals at least one database to begin configuring the one of the second communication group, the second communication group communication pathway, and the second communication group communication.

13. The method of claim 1, wherein at least one database is configured to announce the presence of the at least one of the second communication group, the second communication group, the second communication group communication pathway, the second communication group communication.

14. The method of claim 1, wherein at least one database is provisioned with at least one of a user identification, first and second access technology communication device identifications, first and second access technology communication device capability information, first and second access technology communication device attribute information, first and second access technology capability information, first and second access technology attribute information, and group policies.

15. The method of claim 1, wherein at least one database is configured to correlate a user and a first and a second access technology device information.

16. The method of claim 1, wherein at least one database is configured to determine a mode of transmission for the second communication group communication, the mode of transmission for the second communication group communication using a different access technology for a first user in the group of users than a second user in the group of users.

17. The method of claim 1, wherein a disparate network group manager manages at least one database configured for enabling the first communication group of the first access technology with first access technology communication devices to trigger one of the second communication group, the second communication group communication pathway, and the second communication group communication using second access technology communication devices.

18. The method of claim 1 wherein a disparate network group manager is configured for determining the users of the first communication group to include in the second communication group, determining appropriate second access technologies for a second communication group communication, and applying group policies for first and second communication group communications.

19. The method of claim 1, wherein the presence of one of the second communication group and a second communication group communication pathway is announced and a quantity of the users of the group of users is not authorized to establish the one of the second communication group and the second communication group communication pathway.

20. The method of claim 1, wherein the users of the second communication group each have dissimilar second access technology communication devices capable of receiving the announcement of the one of the second communication group, the second communication group communication pathway, and the second communication group communication and the dissimilar second access technology communication devices are each capable of signaling at least one database to establish a second communication group communication pathway.

21. A method for enabling a first group communication of a first access technology with first access technology communication devices to trigger the creation of a second group communication of a second access technology, with second access technology communication devices, wherein a group of users have first access technology communication device and second access technology communication devices, the method comprising the steps of:
initiating a first group communication pathway using a first access technology with first access technology communication devices;
determining the feasibility of a second group communication pathway using a second access technology with second access technology communication devices;
announcing a presence of the second group communication pathway on the second access technology communication devices; and
enabling the second group communication.
